(19) United States
(12) Patent Application Publication
(10) Pub. No.: US 2026/0131658 A1
(43) Pub. Date: May 14, 2026

(54) AUTOREVERSION CIRCUIT FOR SPACECRAFT DISPLAYS PERFORMED USING HARDWARE IMPLEMENTATION

(71) Applicant: Blue Origin, LLC, Kent, WA (US)

(72) Inventor: Dragos Popescu, Kent, WA (US)

(21) Appl. No.: 18/946,761

(22) Filed: Nov. 13, 2024

(51) Int. Cl. B60K 35/81; B60K 35/90

(52) U.S. Cl. CPC B60K 35/81; B60K 35/90; B60K 2360/184

(57) ABSTRACT

A system comprising a first display and a second display configured to display first and second content, respectively. The system further comprises an avionics computer configured to: process a fault status signal received from the first display; and in response, set an automatic reversion signal to a ground state, wherein setting the automatic reversion signal to the ground state causes the first display to transition away from an on state and instruct the second display to display at least in part the first content. The system further comprises a diode. The system further comprises a display controller comprising a first terminal, a second terminal, and a third terminal, wherein the first and second terminals are coupled to a first end of the diode, and wherein the third terminal is coupled to a second end of the diode and the avionics computer.

### TECHNICAL FIELD

The present disclosure generally relates to a flight display reversion that may be implemented in spacecraft, among other vehicles.

### BACKGROUND

Pilots and ground crew of spacecraft rely on display units to view flight information, such as cruising speed, altitude, and attitude during flight. Monitoring the display units provides pilots and ground crew information to assist with controlling maneuvers of the spacecraft. However, flight displays are prone to encountering faults, which may cause the display to be unable to update with current information. Faults occurring in the flight display unit can deprive a pilot and ground crew of critical flight information, compromising the ability to maintain control of the spacecraft. The loss of a flight display unit can significantly impair flight safety and require prompt action from the pilot and/or the ground crew to mitigate risks and ensure a safe outcome.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system comprising a first display configured to display first content. The system further comprises a second display configured to display second content. The system further comprises avionics computer coupled to the first display and the second display, where computer-executable instructions, when executed by a processor of the avionics computer, cause the avionics computer to: process a fault status signal received from the first display, where the fault status signal indicates a display failure of the first display; in response to receiving the fault status signal, set an automatic reversion signal to a ground state, where setting the automatic reversion signal to the ground state causes the first display to transition away from an on state and instruct the second display to display at least in part the first content. The system further comprises a diode. The system further comprises a display controller comprising a first terminal, a second terminal, and a third terminal, where the first and second terminals are coupled to a first end of the diode, and where the third terminal is coupled to a second end of the diode and the avionics computer.

The system of the preceding paragraph can include any sub-combination of the following features: where the second display is further configured to display the first content and the second content in response to an instruction from the avionics computer; where one of the first terminal, the second terminal, and the third terminal is a recovery command terminal configured to receive a user interaction, where in response to the user interaction, the display controller is configured to transmit a recovery signal to the avionics computer, where transmitting the recovery signal causes the first display to display the first content and the second display to display the second content; where the first end is a cathode end of the diode.

Another aspect of the disclosure provides a system, including: a first display configured to display first content. The system further comprises a second display configured to display second content. The system further comprises an avionics computer, where computer-executable instructions, when executed by a processor of the avionics computer, cause the avionics computer to set an automatic reversion signal to a ground state, where setting the automatic reversion signal to the ground state causes the second display to display at least in part the first content. The system further comprises a display controller comprising a first terminal, a second terminal, and a third terminal, where the third terminal is coupled to the avionics computer and is electrically isolated from the first terminal and the second terminal.

The system of the preceding paragraph can include any sub-combination of the following features: where one of the first terminal, the second terminal, and the third terminal is configured to receive a user interaction to perform a recovery command, where in response to the user interaction, the display controller is configured to transmit a recovery signal to the first display and the second display, where the first display is configured to display the first content when the first display receives the recovery signal, and where the second display is configured to display the second content when the second display receives the recovery signal; where the avionics computer is further configured to: process a fault status signal received from the first display, where the fault status signal indicates a display failure of the first display, and in response to receiving the fault status signal, set the automatic reversion signal to the ground state; where the display failure is at least one of a hardware failure, a software failure, a communication failure, or a sensor failure; where the first display is a primary flight display and the second display is a multi-functional display; where the first display is a multi-functional display and the second display is a primary flight display; the second display is further configured to display the first content and second content in response to an instruction from the avionics computer; where the second terminal is connected to the third terminal; where the system further comprises an electrical component configured to isolate the first terminal from the second terminal and the third terminal; where the electrical component is a diode.

Another aspect of the disclosure provides a system, comprising a first display configured to display first content. The system further comprises a second display configured to display second content. The system further comprises an avionics computer, coupled to the first display and the second display, and configured to transmit an automatic reversion signal, where transmitting the automatic reversion signal causes the second display to display at least in part the first content, where the automatic reversion signal is output from a terminal of the avionics computer in response to the avionics computer detecting a fault. The system further comprises a display controller comprising a first terminal, a second terminal, and a third terminal, where the third terminal is coupled to the avionics computer and is electrically isolated from the first terminal and the second terminal, where the automatic reversion signal is output to the third terminal of the display controller and the first display without closing a circuit between the first and second terminals.

The system of the preceding paragraph can include any sub-combination of the following features: where the avionics computer is further configured to process a fault status signal received from the first display, where the fault status signal indicates a display failure of the first display and in response to receiving the fault status signal, transmit the automatic reversion signal; and in response to receiving the fault status signal, set the automatic reversion signal to the ground state; where the display failure is at least one of a hardware failure, a software failure, a communication failure, or a sensor failure; where the first display is a primary flight display and the second display is a multi-functional display; where the first display is a multi-functional display and the second display is a primary flight display; where the second display is further configured to display the first content and second content in response to an instruction from the avionics computer.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1A illustrates a flight display system of a spacecraft.

FIG. 1B illustrates the system when the first display unit faults and reverts graphics to the second display unit according to a hardware-based autoreversion process as disclosed herein.

FIG. 2 illustrates a circuit implemented within the flight display system of FIG. 1A that enables hardware-based autoreversion.

FIG. 3 illustrates a flow diagram depicting an autoreversion routine as described in examples herein.

### DETAILED DESCRIPTION OF SPECIFIC EMBODIMENTS

Flight display malfunctions or failures can deprive a pilot of essential flight information, compromising their ability to maintain control of a spacecraft. In some cases, the failed display may freeze, failing to update the flight content over time. The pilot may recognize the frozen content on the failed or malfunctioning display and attempt to revert the flight content to a secondary flight display. Reverting the flight content may cause a secondary flight display to display the flight content of the failed or malfunctioning display in addition to the secondary flight content already displayed on the secondary flight display. Traditionally, pilots have been able to revert a failed display using one of two methods: a manual reversion circuit or a software-based autoreversion.

For vehicles equipped with a conventional manual reversion circuit, a pilot could revert the flight content in response to a failed or malfunctioning flight display unit by engaging a display controller operating in the cockpit. The pilot may engage the display controller in the form of a switch, dial, and/or push button. Engaging the display controller may trigger the conventional manual reversion circuit to cause the secondary display unit to display the flight content of the failed or malfunctioning display unit.

Manual reversion, however, can increase a pilot's already busy workload, especially during critical phases of flight (e.g., taxing, takeoff, approach, landing, and/or the like). Relying on pilots to manually revert a failed display can result in pilot error, where a pilot may incorrectly interpret data and/or improperly adjust backup instruments. Additionally, manual reversion can disrupt a pilot's situational awareness as pilot's must momentarily direct their attention towards a switch and/or dial in the cockpit. Manual reversion, therefore, may be an impractical reversion solution in many contexts as a pilot's workload is typically at capacity, leaving little to no room for additional tasks.

A software-based autoreversion may address some of the technical issues with a conventional manual reversion circuit. In some examples, an avionics computer may detect a fault associated with a failed or malfunctioning display unit. In response, the avionics computer may determine an available secondary display screen to receive the flight content of the failed or malfunctioning display unit. The avionics computer may automatically transition the flight content from the failed or malfunctioning display unit to the secondary display. Autoreversion via software may reduce a pilot's workload, as the pilot (and/or a ground crew) does not have to intervene in the reversion process.

However, a purely software-based approach may suffer from rigorous implementation standards and susceptibility to environmental interference. For example, an avionics computer that implements software-based autoreversion may be costly and difficult to design because the manner in which the source code of the software is written may be limited to ensure that the software meets design, testing, and/or qualification standards that reduce the likelihood of aviation accidents (e.g., Software Considerations in Airborne Systems and Equipment Certifications DO-178C, and/or the like). Complex and extensive software qualification testing can include requirements-based testing, structural coverage analysis, traceability analysis, and/or the like. Often, source code of autoreversion software may not meet such rigorous testing requirements, thereby delaying flight schedules and/or involving redesigns to software architectures and implementations. As another example, even if source code of autoreversion software meets the extensive qualification requirements set by regulators, a software-based method of autoreversion may still be susceptible to radiation-based environmental effects given that such software may be operating on avionics computers located in spacecraft operating in high radiation environments like space. Radiation-based environmental effects can result in a single event upset (SEU), where the software may erroneously trigger an autoreversion. Thus, a software-based autoreversion solution may prove to be a technically complicated and unreliable method of reverting a display.

Accordingly, described herein is an improved autoreversion system that employs a hardware-based method for automatically reverting a flight display unit (such as a primary flight display (PFD) and/or another flight-critical display). A hardware-based autoreversion method can include a circuit that automatically triggers reversion of the failed display unit in response to an avionics computer detecting a display fault. The detected fault may originate from a display unit, a display controller, an avionics computer, and/or another hardware or software component as described herein. A hardware-based autoreversion approach improves the reliability of a traditional manual reversion circuit by integrating automatic display fault detection and reversion. For example, hardware-based autoreversion may include an avionics computer to provide enhanced fault detection capabilities by monitoring display fault messages from the display units. In response to detecting the display fault, the hardware-based autoreversion automatically reverts flight content from the failed display to a secondary display unit. In this manner, the hardware-based autoreversion avoids relying on the pilot's observation of the display fault. Additionally, applying a hardware-based autoreversion approach can improve robustness of the reversion capabilities as compared to a purely software-based autoreversion approach. For example, a hardware-based autoreversion approach may be less susceptible to the radiation-based environments in which a spacecraft operates, therefore reducing the risk of SEUs and thus an erroneous autoreversion. Thus, hardware-based autoreversion enhances the spacecraft's reaction capabilities to display unit faults and improves robustness over software-based autoreversion.

The foregoing aspects and many of the attendant advantages of this disclosure will become more readily appreciated as the same become better understood by reference to the following detailed description, when taken in conjunction with the accompanying drawings.

### 1. Example Spacecraft Cockpit Environment

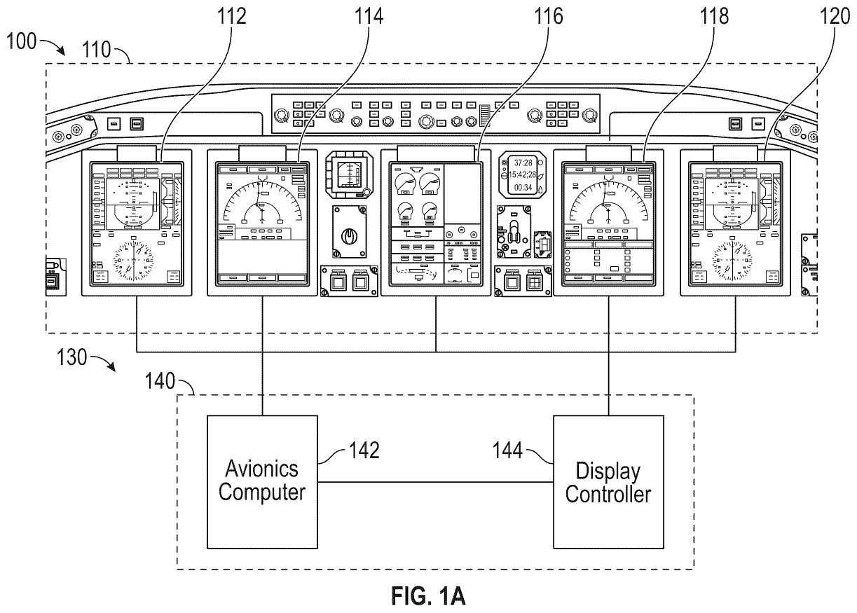

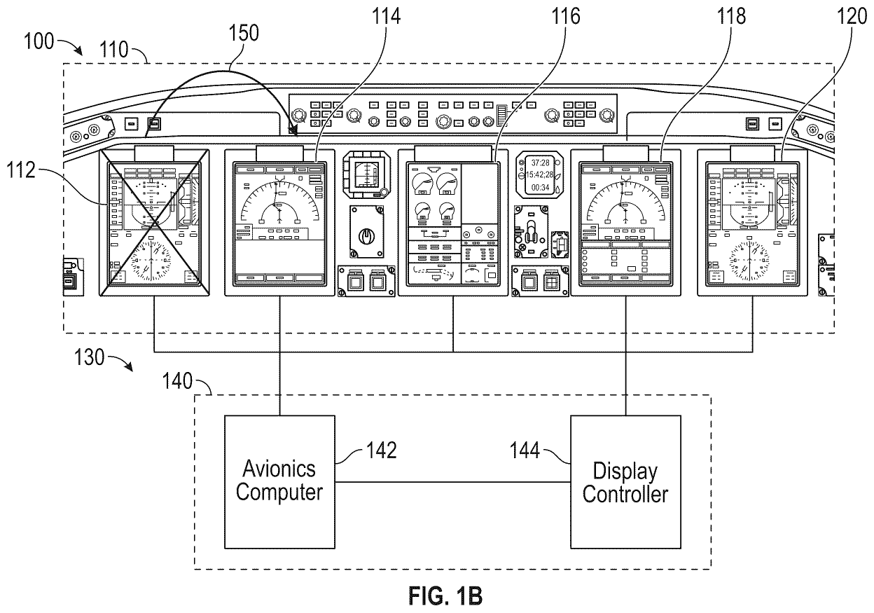

FIG. 1A illustrates a flight display system 100 of a spacecraft. The spacecraft can be any manned and/or unmanned device in orbit around a celestial body, traveling through space, and/or on or near the surface of a celestial body. For example, the spacecraft may include a launch vehicle (e.g., a shuttle, rocket, and/or the like), terrestrial vehicle (e.g., watercraft, aircraft, handheld device, wearable device, rover, and/or the like), space station, capsule, probe, orbiter, lander (e.g., lunar lander), rover, module, interplanetary communication hub, and/or the like. The system 100 may include a cockpit environment 110, wired (or wireless) path 130, and controls 140. The cockpit environment 110 may provide display interfaces to a pilot for maneuvering a spacecraft (or other type of vehicle). The cockpit environment 110 may include a first display unit 112, a second display unit 114, a third display unit 116, a fourth display unit 118, and a fifth display unit 120. In some examples, the first display unit 112, the second display unit 114, the third display unit 116, the fourth display unit 118, and the fifth display unit 120 may be one or more primary flight displays (may also be referred to as “PFD”), one or more multi-functional flight displays (may also be referred to as “MFD”), and/or an engine monitor display (may also be referred to as “engine-indicating and crew-alerting system” or “EICAS”). The number of display units illustrated in FIG. 1A is merely exemplary as the cockpit environment 110 can include any number of display units.

In some instances, the first display unit 112 (may also be applicable to the second display unit 114, the third display unit 116, the fourth display unit 118, and/or the fifth display unit 120) may include hardware and/or software to provide flight information to the pilot and/or ground crew. In some examples, the first display unit 112 may display first content. The first content, for example, may include attitude (e.g., pitch and roll), airspeed, altitude, vertical speed, heading, navigation information, and/or the like. The first display unit 112 may receive inputs from one or more sensors and/or systems associated with the spacecraft. For example, the first display unit 112 may receive and display information from inertial sensors, a global positioning system (GPS), autopilot systems, communication systems, and/or the like. The first display unit 112 may be integrated with one or more displays (one or more of the second display unit 114, third display unit 116, fourth display unit 118, and/or the fifth display unit 120) via for example, an avionics computer 142 and/or display controller 144, to provide a pilot with flight information as described above.

The second display unit 114 (may also be applicable to the first display unit 112, the third display unit 116, the fourth display unit 118, and/or the fifth display unit 120) may receive, display, and/or transmit information to/from an avionics computer 142, a display controller 144, and/or sensors. In some examples, the second display unit 114 may display the same and/or similar flight information as the first display unit 112. In some examples, the second display unit 114 may display second content. In some examples, the second content is different than the first content. For example, information typically displayed via the second display unit 114 may include navigation data (e.g., maps, waypoints, routes, airspace boundaries and/or the like), weather including but not limited to radar imagery, Meteorological Aerodrome Reports (METARs), terrain awareness information, traffic information, spacecraft system status (e.g., fuel, electrical system status, and/or the like), checklists and/or procedures, performance data, and/or the like. Additionally, and/or optionally, the second display unit 114 may display graphics associated with the first display unit 112 in the event that the display controller 144 and/or the avionics computer 142 determines that the first display unit 112 encountered a display fault. One or more of the display units 112, 114, 116, 118, 120 may be connected to organize and display flight information such as navigation data, communication data, telemetry data, ephemeris data, and/or other information relevant to a pilot for maneuvering a spacecraft (or other type of vehicle). Additionally, the system 100 may be implemented in one or more additional vehicles, such as a spacecraft.

The controls 140 may include an avionics computer 142 and a display controller 144. The avionics computer 142 may include hardware and/or software associated with the organization, operation, and display of content on one or more of the displays. The avionics computer 142 may determine a fault with one or more of the displays. In some examples, the avionics computer 142 may determine the fault based on a received fault status signal. In response to the received fault status signal from one or more of the displays, the avionics computer 142 may determine, arrange, and/or instruct flight content to display on one or more displays. The avionics computer 142 may include one or more outputs to indicate that a display has failed. For example, the avionics computer 142 may include discrete output(s) configured to instruct the first display unit 112, second display unit 114, third display unit 116, fourth display unit 118, and/or fifth display unit 120 to enter a STANDBY/SHUTDOWN mode and/or an ON mode. In some cases, the avionics computer 142 may instruct a display to enter an operating mode based on a detected fault associated with a fault signal received from one or more displays. The avionics computer 142 may include a communication bus. The communication bus may transmit and/or receive a message from the avionics computer 142 and/or another system associated with a spacecraft. A communication bus may be any bus type capable of transmitting and/or receiving a command status message, including but not limited to RS-422, RS-485, ARINC-429, MIL-STD-1553A/B/C (and/or STANAG 3838, IEEE 1394), Ethernet, BLE, WIFI (IEEE or other), 3G, 4G, 5G, IEEE 802 series (such as, IEEE 802.11 and 802.3), Controller Area Network, Ethernet, Universal Asynchronous Receiver-Transmitter (UART), discrete signals, and/or another communication protocol relevant to the application disclosed herein. In response to receiving a command status message, an avionics computer 142 may, among other things, direct graphics from a failed display to a secondary display and/or the like.

The display controller 144 may include hardware and/or software to facilitate the operation of the first display unit 112, second display unit 114, third display unit 116, fourth display unit 118, and/or fifth display unit 120. The display controller 144 may include several inputs and/or outputs for determining when to display graphics on one or more displays. The display controller 144 may receive an input from, for example, an avionics computer 142, indicating that one or more displays has malfunctioned. Additionally, and/or optionally, the display controller 144 may include one or more outputs for instructing a display to enter an operating mode. For example, the display controller 144 may include discrete output(s) configured to instruct one or more displays to enter a STANDBY/SHUTDOWN mode and/or an ON mode. In some cases, the display controller 144 may instruct one or more of the displays to enter an operating mode based on a received input from the avionics computer 142. In some instances, the display controller 144 may include a communication bus as described herein to transmit a command status. The command status message may, among other things, instruct an avionics computer 142 to direct graphics from a failed display to a secondary display and/or the like.

FIG. 1B illustrates the system 100 when the first display unit 112 faults and reverts graphics to the second display unit 114 according to a hardware-based autoreversion process as disclosed herein. The display controller 144 may transmit instructions to an avionics computer 142 to display first content, such as a spacecraft's navigation data, on the first display unit 112 during various phases of flight (for example, launch, ascent, orbital insertion, entry, takeoff, climb, descent, approach, landing and/or the like). The avionics computer 142 may receive information from the first display unit 112 indicative of the first display unit 112 malfunctioning (as indicated in FIG. 1B as an “X” across the first display unit 112). The display fault may restrict the first display unit 112 from displaying the first content, appearing frozen on a screen, unable to update the content, or another type of fault or failure. In some examples, the avionics computer 142 may detect failures associated with a flight display unit such as hardware failures (e.g., dead pixels within a display screen, flickering, electrical problems such as a failed connection and/or power supply, and/or the like), software failures such as a glitch, and/or communication failures such as sensor data sources and/or data links providing unreliable information. In response, the avionics computer 142 may automatically revert graphics from the first display unit 112 to the second display unit 114 (or another one or more displays, such as third display unit 116, fourth display unit 118, and/or fifth display unit 120) as described herein. In some examples, when the first display unit 112 faults, the first content previously displayed on the first display unit 112 may revert to the second display unit 114 as shown with flight content reversion path 150. The flight content reversion path 150 illustratively shows the path content might take when a display unit experiences a display fault. For example, the first content shown on the first display unit 112 transfers to being displayed on the second display unit 114. The flight content reversion path 150 illustrates this transfer of displaying flight content from the first display unit 112 to the second display unit 114.

The first display unit 112 (the second display unit 114, the third display unit 116, the fourth display unit 118, and the fifth display unit 120) may transmit a fault signal to the avionics computer 142. The fault signal may be a packet of data that indicates an operation status of the first display unit 112. The operation status may correspond with various operation states, such as normal operation, abnormal operation, fault, and/or the like. The packet of data may correspond with a communication protocol, such as RS-422, RS-485, ARINC-429, MIL-STD-1553A/B/C (and/or STANAG 3838, IEEE 1394), Ethernet, BLE, WIFI (IEEE or other), 3G, 4G, 5G, IEEE 802 series (such as, IEEE 802.11 and 802.3), Controller Area Network, Ethernet, UART, discrete signals, and/or another communication protocol relevant to the application disclosed herein. The fault signal may define the arrangement and presentation of flight information of the first display unit 112. The fault signal may include information indicating, among other things, a fault status of the first display unit 112. The fault status may include information regarding a fault and/or failure of the first display unit 112. For example, the fault may restrict the first display unit 112 from displaying the first content, appearing frozen on a screen, unable to update the content, or another type of fault or failure. In some examples, the avionics computer 142 may detect failures associated with a flight display unit such as hardware failures (e.g., dead pixels within a display screen, flickering, electrical problems such as a failed connection and/or power supply, and/or the like), software failures such as a glitch, and/or communication failures such as sensor data sources and/or data links providing unreliable information. In some examples, an avionics computer 142 may receive and assess the fault status and automatically revert content from a failed display unit (such as the first display unit 112) via a hardware-based autoreversion circuit, such as via circuit 200 described below.

### 2. Example Flight Display Reversion Circuit

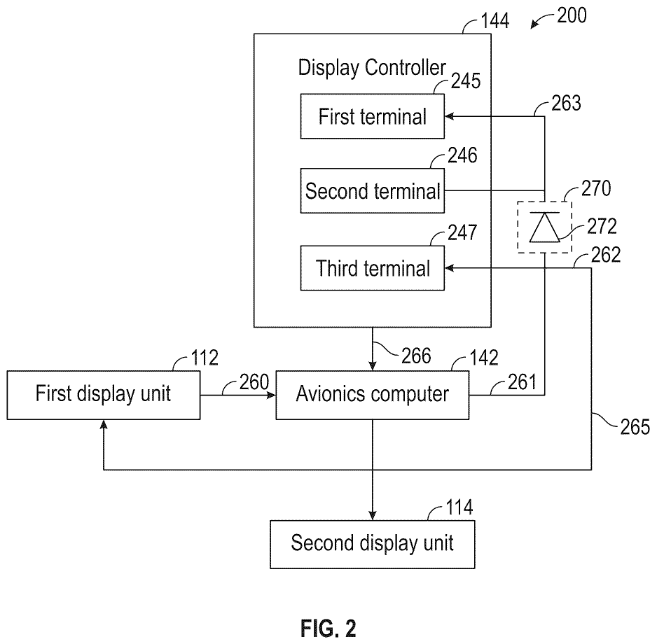

FIG. 2 illustrates a circuit 200 implemented within the flight display system 100 of FIG. 1A that enables hardware-based autoreversion. The circuit 200 may include the first display unit 112, the second display unit 114, the avionics computer 142, the display controller 144, and an electrical component 270.

The display controller 144 may include a first terminal 245, a second terminal 246, and a third terminal 247. The first terminal 245 may represent a reversion command port (e.g., “PFD REV CMD terminal”). The second terminal 246 may represent a recover command port (e.g., “PFD RECOVER CMD terminal”). The third terminal 247 may represent a reversion status port (e.g., “REV STATUS terminal”). Typically, such as in conventional manual reversion circuits, a REV STATUS terminal may communicate a state of the PFD REV CMD terminal to a first display unit 112 (may also be referred to herein as “PFD”) and/or an avionics computer 142. A path 263 may couple the first terminal 245 with the second terminal 246 in certain circumstances. For example, a switch (not shown) may be present in the path 263. In normal conditions (e.g., no display fault has occurred, or a pilot has otherwise not detected a display fault), the switch may be open such that an open circuit exists between the first terminal 245 and the second terminal 246 (and therefore no current flows between the two terminals 245 and 246). Generally, if the pilot detects a display fault (such as with respect to the first display unit 112), the pilot may attempt to perform a manual reversion by closing the switch via a reversion knob, dial, or switch present in the cockpit. With the switch being closed, current may pass between the first terminal 245 and the second terminal 246. Specifically, when the switch is closed, current may flow from the second terminal 246 to the first terminal 245 via path 263, grounding the first terminal 245.

When the switch is closed, the display controller 144 may detect the grounded signal flowing to the first terminal 245, which may cause the display controller 144 to output a grounded signal via the third terminal 247 and to output a command status signal or message to the avionics computer 142 via path 266 that indicates to the avionics computer 142 that the pilot has engaged the reversion knob, dial, or switch (e.g., with respect to the first display unit 112). The third terminal 247 may be coupled to the first display unit 112 (and/or other display units 114, 116, 118, 120, etc.) via path 265. Alternatively, the display controller 144 may include a separate reversion status port for each display unit 112, 114, 116, 118, and 120, where the third terminal 247 is then coupled to the first display unit 112 only. Thus, the first display unit 112 may receive the grounded signal. Receiving the grounded signal may cause the first display unit 112 to transition from an ON mode to a STANDBY/SHUTDOWN mode. In response to the command status signal being output to the avionics computer 142, the avionics computer 142 may transmit content or a user interface originally intended for the first display unit 112 to the second display unit 114 (or other display units 116, 118, 120, etc.) instead. The second display unit 114 may also be referred to here as “MFD.” The MFD may then display content originally intended for the first display unit 112 and second content (content originally displayed on the MFD).

Additionally and/or alternatively, the REV STATUS terminal may transmit an operating mode via a discrete output to a discrete input of the PFD. In the event of the PFD encountering a display fault, an operating mode instruction from the avionics computer 142 (and/or the REV STATUS terminal) may instruct the PFD to enter a powered down mode (such as STANDBY/SHUTDOWN mode). Additionally and/or alternatively, the REV STATUS terminal may indicate to additional circuits and/or systems within a spacecraft (or other vehicle as disclosed herein) that the PFD has failed via one or more wired paths of the circuit 200.

To recover or reset the first display unit 112 (or any other display unit 114, 116, 118, 120, etc. that experienced a fault or malfunction), the pilot may disengage the reversion knob, dial, or switch and/or engage a separate recovery knob, dial, or switch. In response, the switch between the first terminal 245 and the second terminal 246 may be opened (e.g., the closed circuit between the first terminal 245 and the second terminal 246 may be opened again) such that no current flows between the first terminal 245 and the second terminal 246. In response to the switch becoming open again, the display controller 144 may no longer output a grounded signal via the third terminal 247 and/or may output a command status signal to the avionics computer 142 via path 266 that indicates to the avionics computer 142 that the pilot has disengaged the reversion knob, dial, or switch and/or engaged the recover knob, dial, or switch. For example, the REV STATUS terminal may detect there is no current flowing between the PFD REV CMD terminal and the PFD RECOVER CMD terminal and may generate a command status signal or message. The command status signal or message may instruct the avionics computer 142 to direct graphics from the MFD to the PFD. In response, the first display unit 112 may no longer receive the grounded signal via the third terminal 247, which may cause the first display unit 112 to transition from the STANDBY/SHUTDOWN mode to the ON mode. Additionally and/or alternatively, the REV STATUS terminal may transmit an operating mode to a discrete input of the PFD, instructing the PFD to enter an ON mode. In addition, the avionics computer 142 may begin to once again transmit content or a user interface originally intended for the first display unit 112 to the first display unit 112 instead of to the second display unit 114 (or other display units 116, 118, 120, etc.).

To implement the hardware-based autoreversion, the avionics computer 142 may be modified to include an additional port in which an automatic reversion signal may be output in certain circumstances via path 261. In some examples, path 261 may couple the additional port of the avionics computer 142 with the third terminal 247 of the display controller 144. In addition, the electrical component 270 may be added between path 261 and path 263. In other words, the electrical component 270 may prevent the automatic reversion signal output along path 261 from directly intersecting with the path 263 between the first terminal 245 and the second terminal 246. For example, the path 261 may couple the additional port of the avionics computer 142 with one end of the electrical component 270 (e.g., an anode of diode 272), with third terminal 247 of the display controller 144, with the first display unit 112, optionally with other display units 114, 116, 118, 120, etc., and/or with other components (not shown) of the flight display system 100.

The placement and usage of the electrical component 270 may allow the reversion and/or recovery knobs, dials, or switches to operate in the same manner as with a conventional manual reversion circuit. Thus, a pilot may continue to use the reversion and/or recovery knobs, dials, or switches if desired. However, the placement and usage of the electrical component 270 allows for display unit reversions to occur automatically upon the detection of a fault or malfunction even if a pilot does not realize the fault or malfunction or otherwise does not engage the reversion knob, dial or switch and allows for the pilot to recover a display unit manually even if the display unit reversion occurred automatically without pilot input.

For example, the avionics computer 142 may receive a fault status signal indicating a display failure of the first display unit 112 via path 260 (or another display unit as disclosed herein) and/or from the display controller 144 via path 266. In response to receiving the fault status signal, the avionics computer 142 can simulate engagement of the reversion knob, dial, or switch by setting an automatic reversion signal to ground (may be referred herein to as “GND”) and outputting the automatic reversion signal along path 261. Thus, the third terminal 247 of the display controller 144, one end of the electrical component 270, and an input of the first display unit 112 may receive a GND signal, which is an action that would also occur if the pilot had engaged the reversion knob, dial, or switch. Reception of the GND signal may cause the first display unit 112 to enter a powered down state (e.g., a STANDBY/SHUTDOWN mode), as described above. The powered down state may include the first display unit 112 shutting down and/or being on standby. In response to receiving the fault status signal, the avionics computer 142 may also transmit content or a user interface originally intended for the first display unit 112 to the second display unit 114. In some examples, the avionics computer 142 may instruct the second display unit 114 to display content in response to the first display unit 112 experiencing a display fault. In this manner, the avionics computer 142 may revert the display from the first display unit 112 to the second display unit 114. Thus, the second display unit 114 may display at least in part the content previously displayed on the first display unit 112. In some examples, the second display unit 114 is further configured to display the content previously displayed on the first display unit 112 and second content originally displayed on the second display unit 114 in response to the avionics computer 142 receiving the fault status signal.

The electrical component 270 may prevent the GND signal output by the avionics computer 142 via path 261 from also grounding the path 263 (e.g., closing the circuit) between the first terminal 245 and the second terminal 246. If the path 263 was automatically grounded, the recovery knob, dial, or switch may not work as intended. Thus, because the path 263 is not automatically grounded with then GND signal is output, the pilot may still use the recovery knob, dial, or switch to recover the first display unit 112 if desired.

In some examples, the electrical component 270 may be at least one of a diode (such as diode 272), an electrical switch, or a mechanical switch. Alternatively, the circuit 200 may not include the electrical component 270. Rather, the wired path 261 may terminate before the path 263. In this manner, the path 263 is separate from the wired path 261 and there are no circuit components between the first portion 262 and the path 263, such that there is no physical connection between the wired path 261 and the path 263.

In some instances, the plurality of terminals 245-247 of the display controller 144 may correspond with various input commands. For example, the first terminal 245 may be a PFD reversion command terminal (may also be referred to herein as “PFD REV CMD”). The second terminal 246 may be a PFD recovery command terminal (may also be referred to herein as “PFD RECOVER CMD”). The third terminal 247 may be a reversion status terminal (may also be referred to herein as “REV STATUS”).

In some examples, the circuit 200 may additionally or alternatively include a manual recovery capability. For example, a pilot may manually recover the failed display unit (such as the first display unit 112) via a user input. The user input may be a recovery push-button, a switch, a dial, a knob and/or another other input that may be operated by the pilot. The user input may be electrically connected to one or more of the first terminal 245, the second terminal 246, and the third terminal 247. The display controller 144 may include several terminals, such as discrete inputs and/or outputs to facilitate a manual recovery.

### Detailed Hardware-Based Autoreversion Operation

In a hardware-based autoreversion operation, an avionics computer (such as avionics computer 142) may assess a fault signal of the spacecraft's display units, and automatically revert content from a failed display unit to a viable display unit. In some examples, the hardware-based autoreversion may be a modified version of the manual reversion circuit. However, instead of or in addition to the pilot (and/or ground operator(s)) seeking to start the reversion process, the avionics computer 142 may prompt a display reversion. In this manner, the avionics computer 142 may detect a display fault of the first display unit 112. For example, the first display unit 112 may transmit a fault status signal (such as a Display Unit WRAP message) to the avionics computer 142. The fault status signal may be a data packet of information that indicates an operation status of the first display unit 112. In some instances, the circuit 200 may perform autoreversion without software reversion actions. In the event that the fault status signal fails to indicate an operational status or affirmatively provides a failure status, the avionics computer 142 may assess a failure of the first display unit 112. In some examples, any or all of the display units connected to the avionics computer 142 may transmit the fault status signal.

Unlike a manual reversion circuit, the circuit 200 can include an additional discrete output from the avionics computer 142. The discrete output may be an open/ground discrete output. In some examples, the discrete output may be electrically connected to an electrical component 270. For example, the discrete output may be electrically connected to an anode portion (or cathode portion) of the diode 272. The discrete output may connect to one or more discrete inputs, such as the third terminal 247 (or another of the plurality of terminals). In some examples, the cathode (or anode portion) of the diode 272 may be connected to one or more discrete inputs, such as the first terminal 245 and the second terminal 246 (or another configuration of the plurality of terminals). In some examples, the diode 272 may be placed along the wired path 261. In some instances, an orientation of the diode 272 may provide for electrical isolation between the terminals. For example, the orientation of the diode 272 may include an anode and a cathode. In some examples, when a ground signal reaches the anode of the diode 272, the diode 272 prevents the signal from passing through to the cathode side of the diode 272 (assuming that the ground signal is less than the forward bias voltage). In this manner, the diode 272 may isolate (e.g., electrically isolate) one or more discrete inputs, such as isolating the third terminal 247 from the first terminal 245 and the second terminal 246 from receiving a ground signal from the avionics computer 142. The discrete output of the avionics computer 142 may also be electrically connected to discrete inputs of the first display unit 112 and the second display unit 114.

In some instances, the avionics computer 142 may detect a fault of the first display unit 112. For example, the first display unit 112 may transmit a fault signal to the avionics computer 142. The fault signal may be a packet of data that indicates an operation status of the first display unit 112. The operation status may correspond with various operation states, such as normal operation, abnormal operation, and/or the like. The packet of data may correspond with a communication protocol, such as RS-422, RS-485, ARINC-429, MIL-STD-1553A/B/C (and/or STANAG 3838, IEEE 1394), Ethernet, BLE, WIFI (IEEE or other), 3G, 4G, 5G, IEEE 802 series (such as, IEEE 802.11 and 802.3), Controller Area Network, Ethernet, UART, discrete signals, and/or another communication protocol relevant to the application disclosed herein. The fault signal may define the arrangement and presentation of flight information of the first display unit 112. The fault signal may include information indicating, among other things, a fault status of the first display unit 112. The fault status may include information regarding a fault and/or failure of the first display unit 112. For example, the fault may restrict the first display unit 112 from displaying the first content, appearing frozen on a screen, unable to update the content, or another type of fault or failure. In some examples, the avionics computer 142 may detect failures associated with a flight display unit such as hardware failures (e.g., dead pixels within a display screen, flickering, electrical problems such as a failed connection and/or power supply, and/or the like), software failures such as a glitch, and/or communication failures such as sensor data sources and/or data links providing unreliable information. In some examples, an avionics computer 142 may receive and assess the fault status.

In some instances, the avionics computer 142 may identify the second display unit 114 as viable for autoreversion. In some examples, the avionics computer 142 may identify which display units are viable displays for performing autoreversion. The avionics computer 142 may identify the viable displays based on the operation status messages from each of the available display units. For example, the avionics computer 142 may be connected to a plurality of display units (such as the first display unit 112, second display unit 114, third display unit 116, fourth display unit 118, and fifth display unit 120) and able to receive the operation status messages from each of the display units. The avionics computer 142 may assess a data frame of the operation status message indicating whether the display unit is operating normally. The avionics computer 142 may determine the display unit is operating normally and is a viable display unit for autoreversion of the graphics from the failed display unit.

In some instances, the avionics computer 142 may output an autoreversion signal (such as a discrete signal set to GND) to the display controller 144 (such as the third terminal 247). In some examples, the autoreversion signal may identify the failed display and the viable display. For example, the first display unit 112 as the failed display and the second display unit 114 as the viable display. In some examples, when the display controller 144 receives the autoreversion signal, a circuit between the first terminal 245 and the second terminal 246 closes. For example, in some cases, the avionics computer 142 may cause the electrical component 270 to ground an electrical connection between the first terminal 245 and the second terminal 246. In some cases, the avionics computer 142 may ground the circuit between the first terminal 245 and the second terminal 246 by adjusting a discrete signal to GND. For example, adjusting a discrete signal to the electrical component 270, causing the electrical component 270 to ground the electrical connection between the first terminal 245 and the second terminal 246 (e.g., by electrically isolating as disclosed herein). In some approaches, the avionics computer 142 may indicate via the autoreversion signal for the display controller 144 to ground the circuit between the first terminal 245 and the second terminal 246, as disclosed herein. In other approaches, the avionics computer 142 may ground the circuit between the first terminal 245 and the second terminal 246 using another manner consistent with the architecture as disclosed herein. In this manner, current may begin to flow between the first terminal 245 and the second terminal 246.

In some instances, the third terminal 247 may generate a reversion status signal and transmit to the avionics computer 142 via the command status path 266. The reversion status signal may include an instruction to power down the first display unit 112 (or another affected display unit). In some examples, the reversion status signal may include an instruction to perform graphic autoreversion to the avionics computer 142. In some examples, the avionics computer 142 may instruct the second display unit 114 (or another of the viable display units) to display at least in part the first content. In some examples, the second display unit 114 (or another of the viable display units) may display the first content and the second content in response to an instruction from the avionics computer 142. Thus, the second display unit 114 may then display the first content and the second content.

In some instances, the second terminal 246 may be a recovery command terminal configured to receive a user input. The second terminal 246 may be coupled to a push button, electrical switch, and/or mechanical switch to receive the user input from the pilot. A pilot may operate the push button to an open position to recover the first display unit 112 and allow the first display unit 112 to display the first content. For example, the pilot may interact with the push button to ground a discrete signal of the second terminal 246. When the pilot operates the push button to an open position to ground the discrete signal, the circuit between the second terminal 246 and the first terminal 245 opens. In response, the third terminal 247 may detect there is no current flowing between the first terminal 245 and the second terminal 246 and may generate a command status message via the command status path 266. The command status message may instruct the avionics computer 142 to direct the first content from the MFD back to the PFD. Grounding the third terminal 247 may transmit a recovery signal to the avionics computer 142 to cause the first display unit 112 to enter an ON state and display the first content. In some examples, in response to the user input, the display controller 144 may transmit a recovery signal to the first display unit 112 and the second display unit 114. In some examples, the first display unit 112 is configured to display the first content when the first display unit 112 receives the recovery signal. In some examples, the second display unit 114 is configured to display the second content when the second display unit 114 receives the recovery signal. In this manner, the display units may recover to displaying content that was displayed prior to autoreversion.

### 3. Example Autoreversion Routine

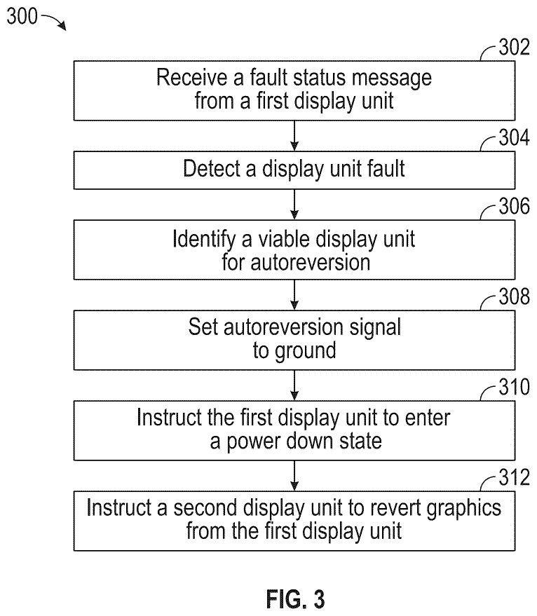

FIG. 3 is a flow diagram depicting an example autoreversion routine 300. The routine 300 may be carried out, for example, by an avionics computer 142 of FIG. 2. The routine 300 begins at block 302, where the avionics computer 142 may receive a fault status signal from a first display unit. The fault status signal may include a data frame of information indicating a fault status of the first display unit. For example, one or more bits of the data frame may indicate an operation status of the first display unit. In some examples, when a portion of the data frame representative of a fault includes bits indicating a fault, the avionics computer 142 may detect the fault of the first display unit.

At block 304, the avionics computer 142 may detect a display unit fault. A fault status may indicate a display unit is malfunctioning or damaged. A fault can originate from hardware failures (e.g., dead pixels within a display screen, flickering, electrical problems such as a failed connection and/or power supply, and/or the like), software failures such as a runtime error, and/or communication failures such as sensor data sources and/or data links providing unreliable information.

At block 306, the avionics computer 142 may identify a viable display unit for autoreversion. The avionics computer 142 may identify the viable displays based on the operation status from each of the available display units. For example, the avionics computer 142 may be connected to a plurality of display units (such as the first display unit 112, second display unit 114, third display unit 116, fourth display unit 118, and fifth display unit 120) and able to receive the operation status from each of the display units. The avionics computer 142 may assess a data frame of the operation status indicating whether the display unit is operating normally. The avionics computer 142 may determine whether the display units operating normally are viable display units for autoreversion of the graphics from the failed display unit.

At block 308, the avionics computer 142 may set an autoreversion signal to ground. In response to receiving the fault status signal, the avionics computer 142 may set an automatic reversion signal to ground (may be referred herein to as “GND”). In some examples, the avionics computer 142 may include a discrete output (such as a terminal) coupled to other components as disclosed herein. The discrete output of the avionics computer 142 may be coupled to a display controller (such as display controller 144 in FIG. 2), a first display unit (such as display units illustrated in FIGS. 1A-2), and optionally a second display unit (such as display units illustrated in FIGS. 1A-2). In some examples, the avionics computer 142 may output a display unit reversion status. The display reversion status may indicate whether the avionics computer 142 plans to attempt to revert, is attempting to revert, or has reverted graphics from the first display unit to the second display unit.

At block 310, the avionics computer 142 may instruct the first display unit to enter a power down state. In some examples, this is an optional step as setting the autoreversion signal to GND may instruct the first display unit 112 to enter a powered down state. The powered down state may include the first display unit 112 shutting down and/or being on standby. In this manner, the first display unit displays no content.

At block 312, the avionics computer 142 may instruct the second display unit to revert (e.g., display) graphics from the first display unit. second display unit 114. In some examples, the second display unit is further configured to display the first content and the second content in response to the avionics computer 142 receiving the fault status message.

### 4. Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system, comprising:
a first display configured to display first content;
a second display configured to display second content;
an avionics computer coupled to the first display and the second display, wherein computer-executable instructions, when executed by a processor of the avionics computer, cause the avionics computer to:
process a fault status signal received from the first display, wherein the fault status signal indicates a display failure of the first display; and
in response to receiving the fault status signal,
set an automatic reversion signal to a ground state, wherein setting the automatic reversion signal to the ground state causes the first display to transition from an on state, and
instruct the second display to display at least in part the first content;
a diode; and
a display controller comprising a first terminal, a second terminal, and a third terminal, wherein the first and second terminals are coupled to a first end of the diode, and wherein the third terminal is coupled to a second end of the diode and the avionics computer.

2. The system of claim 1, wherein the second display is further configured to display the first content and the second content in response to an instruction from the avionics computer.

3. The system of claim 1, wherein one of the first terminal, the second terminal, and the third terminal is a recovery command terminal configured to receive a user interaction, wherein in response to the user interaction, the display controller is configured to transmit a recovery signal to the avionics computer, wherein transmitting the recovery signal causes the first display to display the first content and the second display to display the second content.

4. The system of claim 1, wherein the first end is a cathode end of the diode.

5. A system, comprising:
a first display configured to display first content;
a second display configured to display second content;
an avionics computer, wherein computer-executable instructions, when executed by a processor of the avionics computer, cause the avionics computer to set an automatic reversion signal to a ground state, wherein setting the automatic reversion signal to the ground state causes the second display to display at least in part the first content; and
a display controller comprising a first terminal, a second terminal, and a third terminal, wherein the third terminal is coupled to the avionics computer and is electrically isolated from the first terminal and the second terminal.

6. The system of claim 5, wherein one of the first terminal, the second terminal, and the third terminal is configured to receive a user interaction to perform a recovery command, wherein in response to the user interaction, the display controller is configured to transmit a recovery signal to the first display and the second display, wherein the first display is configured to display the first content when the first display receives the recovery signal, and wherein the second display is configured to display the second content when the second display receives the recovery signal.

7. The system of claim 5, wherein the avionics computer is further configured to:
process a fault status signal received from the first display, wherein the fault status signal indicates a display failure of the first display; and
in response to receiving the fault status signal, set the automatic reversion signal to the ground state.

8. The system of claim 7, wherein the display failure is at least one of a hardware failure, a software failure, a communication failure, or a sensor failure.

9. The system of claim 5, wherein the first display is a primary flight display, and wherein the second display is a multi-functional display.

10. The system of claim 5, wherein the first display is a multi-functional display, and wherein the second display is a primary flight display.

11. The system of claim 5, wherein the second display is further configured to display the first content and second content in response to an instruction from the avionics computer.

12. The system of claim 5, wherein the second terminal is connected to the third terminal.

13. The system of claim 5, wherein the system further comprises an electrical component configured to isolate the first terminal from the second terminal and the third terminal.

14. The system of claim 13, wherein the electrical component is a diode.

15. A system, comprising:
a first display configured to display first content;
a second display configured to display second content;
an avionics computer, coupled to the first display and the second display, and configured to transmit an automatic reversion signal, wherein transmitting the automatic reversion signal causes the second display to display at least in part the first content, wherein the automatic reversion signal is output from a terminal of the avionics computer in response to the avionics computer detecting a fault; and
a display controller comprising a first terminal, a second terminal, and a third terminal, wherein the third terminal is coupled to the avionics computer and is electrically isolated from the first terminal and the second terminal, wherein the automatic reversion signal is output to the third terminal of the display controller and the first display without closing a circuit between the first and second terminals.

16. The system of claim 15, wherein the avionics computer is further configured to:
process a fault status signal received from the first display, wherein the fault status signal indicates a display failure of the first display; and
in response to receiving the fault status signal, transmit the automatic reversion signal.

17. The system of claim 16, wherein the display failure is at least one of a hardware failure, a software failure, a communication failure, or a sensor failure.

18. The system of claim 15, wherein the first display is a primary flight display, and wherein the second display is a multi-functional display.

19. The system of claim 15, wherein the first display is a multi-functional display, and wherein the second display is a primary flight display.

20. The system of claim 15, wherein the second display is further configured to display the first content and second content in response to an instruction from the avionics computer.
